(19) United States
(12) Patent Application Publication
(10) Pub. No.: US 2013/0234525 A1
(43) Pub. Date: Sep. 12, 2013

(54) Electrical breakdown limiter for a high voltage power supply

(71) Applicant: FERROTEC (USA) CORPORATION, Santa Clara, CA (US)

(72) Inventor: Jonathan Nord, Jasper, IN (US)

(73) Assignee: Ferrotec (USA) Corporation, Santa Clara, CA (US)

(21) Appl. No.: 13/786,964

(22) Filed: Mar. 6, 2013

Related U.S. Application Data
(60) Provisional application No. 61/607,059, filed on Mar. 6, 2012.

(51) Int. Cl. H05B 41/26

(52) U.S. Cl. CPC H05B 41/26
USPC 307/99

(57) ABSTRACT

An electrical breakdown limiter circuit and method for a high voltage power supply includes an inductor having an inductor input and an inductor output wherein the inductor is electrically coupled in series between a high voltage output of the high voltage power supply and a load, and a controllable switch electrically coupled in series with the inductor between the high voltage output of the high voltage power supply and the inductor input wherein the controllable switch is opened when an electrical breakdown event at the load is detected downstream from the inductor output that causes a high voltage at the inductor output to decrease, the controllable switch returning to a normally closed position upon clearing of the electrical breakdown.

This application claims the benefit of U.S. Provisional Patent Application No. 61/607,059, filed Mar. 6, 2012.

### BACKGROUND OF THE INVENTION

1. Field of the Invention

The present invention relates generally to high voltage power supplies. Particularly, the present invention relates to a high voltage power supply for producing a controllable, constant high voltage output under varying and arcing loads suitable for powering an ion source such as an electron beam gun.

2. Description of the Prior Art

An electron beam gun is used in a vacuum system for providing a high intensity beam of electrons to bombard a target material. Typically, the target material is evaporated and deposited onto a substrate. The electron beam gun employs a filament connected to a split cathode block having two sides and an anode with a U-shaped cross-section that passes over the filament and terminates in a front edge spaced from and located in front of the filament. A beam former is located between the anode and the filament and is configured so that the filament is shielded from the anode. When an electrical current is applied to the filament through the cathode block, the filament emits electrons. The electrons are constrained to pass beneath the beam former and toward the front edge of the anode due to the shielding of the filament by the beam former, which causes a ribbon-like electron beam. A sufficient kinetic energy is imparted to the electrons so that the electrons miss the anode and emit from the electron beam gun. The emitted, ribbon-like, electron beam is deflected by magnetic pole pieces to direct the beam into the material source to be evaporated. Typically, the deflection is through an arc of about 270°.

During bombardment of the target material by the electron beam, various ionized materials are emitted. The presence of such materials often effects a substantial decrease in the voltage between the various parts of the electron beam gun and other elements. This oftentimes results in arcing between the electron beam gun parts and other structures. Arcing causes a substantial increase in the electron gun current.

In high voltage and high performance applications, physical spacing between the electron beam gun, surrounding components and target materials is relatively small. As a result, the electron beam gun may arc to ground frequently. High voltage power supplies that are useful in these applications are power supplies that use switch-mode DC-DC converters operating at 10 kHz and above. These types of power supplies are compact, operate with a diode rectifier input for high input power, are efficient because they do not operate as linear regulators, require low maintenance because they are solid state, and have good dynamic response because they operate at high frequency.

A series resonant type of a switching DC-DC converter is one type that is useful for high voltage applications above 10 kHz with arcing loads. Power supplies that use series resonant type DC-DC converters have an input rectifier and filter to produce a DC voltage, an inverter consisting of transistors and a resonant network to produce high frequency, a transformer for producing the desired output voltage level, and a rectifier and filter to produce DC for application to the load. However, this is not adequate for high performance power supplies for electron beam guns.

An example of an electrical circuit used in one embodiment of a high voltage power supply in the prior art is shown in FIG. 4. It is noted that the figure is drawn in reverse polarity for simplicity. The typical circuit design includes one or more resistors R1 in series between the output of the high voltage power source and the load. One or more capacitors C1 are electrically coupled between the high side and the low side of the high voltage regulator. This type of electrical circuit has an arc recovery time of about 2-4 milliseconds as illustrated in FIG. 5.

The discharge energy associated with the prior art electrical circuit as shown in FIG. 4 is calculated for a 10 killoVolt (kV) system. The equation used for this calculation is as follows:

E=½(C)(V)² (Eq. 1)

where C is the capacitance and V is the voltage.

As is known to those skilled in the art, this equation represents the amount of energy that is storable in a capacitor, which is the discharge energy associated with the electrical circuit disclosed.

Substituting the capacitance and voltage for the values shown in FIG. 4, the calculated discharge energy becomes as follows:

E=½(34nF)(10kV)²=1.7Joules

According to FIG. 5, this means that it takes 2-4 milliseconds to discharge 1.7 Joules of energy stored in the circuit and to recover to the normal voltage of the high voltage power supply.

### SUMMARY OF THE INVENTION

There exist major deficiencies in high voltage power supplies to date. For example, a couple of the major deficiencies in a switching DC-DC converter type of high voltage power supply is the amount of energy stored in the output filter capacitance. The output current of the inverter is sinusoidal and a substantial capacitance is required after rectification to obtain satisfactory output voltage even though the inverter operates above 10 kHz.

Arcs that are developed in the vacuum during the process of a vapor deposition system, for example, can drain all of the stored energy of the high voltage power supply. After the occurrence of an arc, the high voltage power supply then requires a substantial period of time to recover its original potential.

What is needed is a device that improves the recovery time from an arc event that developed and occurred during processing.

It is an object of the present invention to provide improved arc recovery for a high voltage power supply used in vacuum deposition systems.

The present invention achieves these and other objectives by providing an electrical circuit placed between the output of a high voltage power supply (HVPS) and the load. The electrical circuit controls the amount of energy that can be dissipated into an arc. The electrical circuit may be external or internal to the HVPS. The main concept provides a switch and an inductor in series with the HVPS output that allows the switch to be opened when an electrical breakdown, i.e. an arc, is detected and, as such, to provide a controlled and limited amount of energy to dissipate in the vacuum chamber. Where the amount of potential energy is controlled and limited, the electrical breakdown duration is greatly reduced which prevents the HVPS from being totally discharged. Since the HVPS is not totally discharged, the time from the electrical breakdown to full recovery is greatly reduced.

The basis of control in the electrical circuit is the inductor placed in series with the load that is isolated from the HVPS low impedance output during an electrical breakdown. The high voltage switch is included to interrupt energy flowing from the HVPS output into the inductor. As such the electrical circuit will control the energy dissipated into the electrical breakdown to the energy transferred through the limiting inductance plus the energy stored in the inductor when the switch turns off. To ensure that the current associated with the energy accumulated in the inductor during breakdowns does not cause over-voltages at the load, an optional high side diode is placed on the output side of the inductor. The high side diode conducts the would-be overvoltage load currents and in so doing returns the excess energy from the inductor back to the power supply output.

In one embodiment of the present invention, there is disclosed an electrical breakdown limiter circuit for a high voltage power supply. The electrical breakdown limiter circuit includes (1) an inductor having an inductor input and an inductor output where the inductor is electrically coupled in series between a high voltage output of the high voltage power supply and a load impedance, and (2) a controllable switch electrically coupled in series with the inductor between the high voltage output of the high voltage power supply and the inductor input where the controllable switch is opened when an electrical breakdown event at the load is detected downstream from the inductor output that causes a high voltage at the inductor output to decrease, the controllable switch returning to a normally closed position upon clearing of the electrical breakdown.

In another embodiment of the present invention, there is included a closed electrical circuit loop electrically coupled to the inductor output and the high voltage output of the high voltage power supply wherein the closed electrical circuit loop clamps the voltage to the load to a predefined voltage level. In other words, the closed electrical circuit loop controls the amount of energy transfer into the load. The controllable switch is opened when an electrical breakdown event at the load is detected downstream from the inductor that causes the beam voltage to decrease to or below a predefined voltage level as current in L_{LIMIT} rises and to return to the normally closed position upon current in L_{LIMIT} diminishing back to the normal beam current.

In a further embodiment, the closed electrical circuit loop has a diode. the diode in the closed electrical circuit loop conducts inductor current when the inductor output voltage is substantially equal to or greater than the high voltage output of the high voltage power supply.

In still another embodiment of the present invention, the closed electrical circuit loop includes a high-side diode electrically coupled to the inductor output and the high voltage output of the high voltage power supply and a low-side diode electrically coupled to the inductor input and one of a low side of the high voltage power supply and ground. In yet a further embodiment, the low-side diode is electrically coupled between the inductor input and the controllable switch output.

In another embodiment of the present invention, the high-side diode conducts over-voltage load currents from the inductor output to the high voltage output of the high voltage power supply.

In another embodiment of the present invention, there is disclosed a method of controlling and limiting the amount of energy dissipated during an arc event in a high voltage power system. The method includes (1) electrically coupling an electrical breakdown limiter circuit between a high voltage output of a high voltage power supply and a load impedance, (2) sensing an electrical breakdown event at the load impedance by sensing a decrease in voltage at the inductor output, (3) electrically opening the controllable switch when the voltage at the inductor output is at or below a predefined voltage level, and (4) electrically closing the controllable switch when the voltage at the inductor output recovers to the normal operating voltage and current in L_{LIMIT} diminishes to normal operating current. The electrical limiter circuit has an inductor electrically coupled in series with a controllable switch and a closed electrical circuit loop. The controllable switch is normally closed and is electrically coupled to the high voltage output. The inductor is connected to the load impedance. The closed electrical circuit loop includes L_{LIMIT} of the inductor, DH (high side diode), the high voltage regulator, and DL (low side diode). The inductor and the closed electrical circuit loop limits the rate of rise of electrical current transfer into the load and the controllable switch interrupts the energy transfer from the high voltage output to the load when the arc event is detected that causes the voltage at the high voltage output to decrease to or below the predefined voltage level, thus, preventing the HVPS from completely discharging all of its energy before recovering.

### BRIEF DESCRIPTION OF THE DRAWINGS

FIG. 1 is a simplified circuit diagram showing one embodiment of the present invention for use with a high voltage power supply.

FIG. 2 illustrates the estimated recovery times for arc recovery of the electrical circuit shown in FIG. 1.

FIG. 3 is a flow chart of the operation of the present invention.

FIG. 4 is a simplified circuit diagram showing a prior art electrical circuit used in a high voltage power supply.

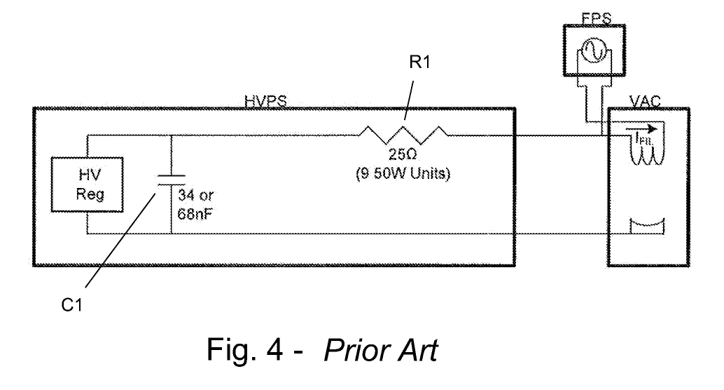

FIG. 5 illustrates the recovery time for arc recovery of the electrical circuit shown in FIG. 4.

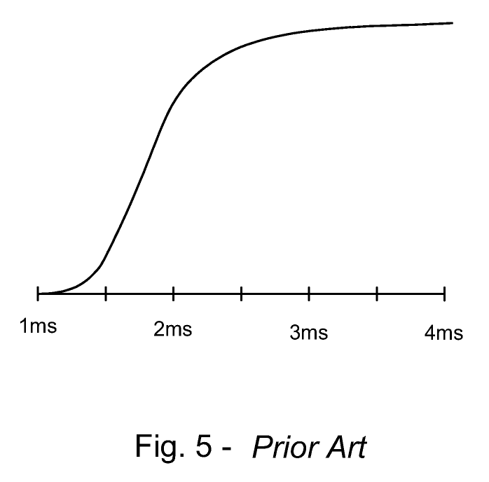

### DETAILED DESCRIPTION OF THE PREFERRED EMBODIMENT

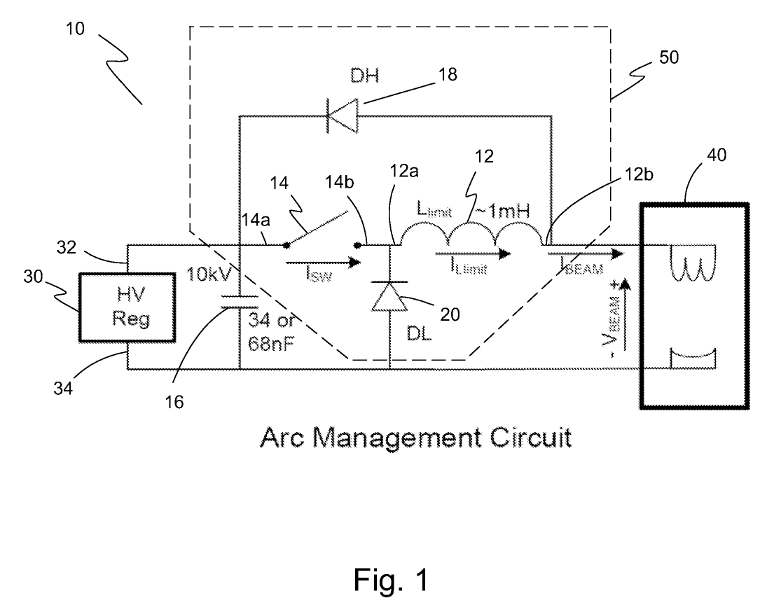

The preferred embodiments of the present invention are illustrated in FIGS. 1-3. FIG. 1 shows one embodiment of a simplified circuit diagram 10 for use in high voltage power supplies as an arc management circuit. For simplicity, circuit diagram 10 depicts a positive supply, however, actual high voltage power supplies for vapor deposition systems may use negative supplies. It is also contemplated the circuit may be external or internal to a high voltage power supply.

Circuit diagram 10 includes an inductor 12 and a switch 14 in series with a high voltage power supply output 32 of a high voltage regulator 30 and the load of the circuit 40. Although switch 14 is shown in an open state, it should be understood that switch 14 is normally in a closed state under normal operation of the high voltage power supply without an arc event and is only triggered open when a predefined arc event occurs. Switch 14 is included to interrupt energy flowing from high voltage power supply output 32, thus, limiting the increase in current in inductor 12. Inductor 12 and switch 14 controls the energy dissipated into an arc to the energy transferred through the limiting inductance plus the energy stored in inductor 12 when switch 14 turns off. A high-side diode 18 clamps V_{beam} to 10 kV in a closed electrical loop comprised of L_{LIMIT}, DH, HV Reg. and DL. Specifically as shown, high-side diode 18 is electrically coupled to the output 12b of inductor 12 and the input 14a of switch 14. High-side diode 18 ensures that the current associated with the energy accumulated in inductor 12 during breakdowns, i.e. arc events, does not cause over-voltages at the load/load impedance. High-side diode 18 conducts the would-be overvoltage load currents and in so doing returns the excess energy from inductor 12 back to the power supply output 32. A low-side diode 20 is electrically coupled between low side 34 of the high voltage power regulator 30 and/or ground and the high voltage power supply output 32 between the output 14b of switch 14 and the input 12a of inductor 12. A capacitor 16 is electrically coupled between high voltage power supply output 32, i.e. the load side, and the low-side 34, i.e. the ground, between switch 14 and the high power voltage regulator 30. In the circuit illustrated, capacitor 16 is either a 34 nF or 68 nF capacitor. Component 40 represents the load impedance that, for vapor deposition systems, is the electron beam gun containing the filament and anode/cathode. For clarity, reference 50 is the electrical breakdown limiter circuit of the present invention (also known as the arc management circuit) that controls the energy dissipated into the breakdown or returned to the high voltage regulator of the high voltage power supply. Not shown in the simplified circuit diagram 10 are the arc detection circuit that senses an arc event and the gate drive circuit that controls switch 14 between a closed state and an open state. Both circuits are known to those skilled in the art.

For purposed of the following example, the power supply is at negative 10 kV as applied to an electron beam system. It is understood, however, that the present invention is applicable to other voltages in positive or negative polarity for other applications such as ion implanting, sputtering and glow discharge. The example will explain in detail the functional operation of the present invention, which includes (1) the rising breakdown current is limited by a series inductor 12 (L_{LIMIT}), (2) a series switch 14 interrupts current from the high voltage regulator output 32 into the breakdown, (3) a minimal amount of the high voltage regulator output energy is transferred into L_{LIMIT}, and (4) energy in L_{LIMIT} is dissipated either into the breakdown or returned to the high voltage regulator, or both.

Initial Instant as Breakdown Begins:

L_{LIMIT} instantaneously limits the breakdown current to a limited rate of rise of (Vₕᵥ−V_{bd}))/1 mH where Vₕᵥ equals the voltage of the high voltage power source and V_{bd} equals the voltage of the breakdown. The L_{LIMIT} rising current wave shape is dependent upon the breakdown behavior from the onset of the breakdown until the instant the high voltage switch 14 turns off. This breakdown behavior defines the V_{bd} as a function of current through the breakdown. The peak current in L_{LIMIT} is dependent upon the time between (1) initial breakdown and turn off and (2) the breakdown behavior above.

The discharge energy associated with inductor 12 as shown in FIG. 1 is calculated for a 10 kVolt (kV) system. The energy stored in an inductor is given by the following equation:

E=½(L)(I)² (Eq. 2)

where L is the inductance of the inductor and I is the current.

Inductance L is the capacity of an inductor to store energy in the form of a magnetic field. The relationship between inductance, voltage, and current is given by the following equation:

L=V(dt/di) (Eq. 3)

where V is the voltage, dt is the change in time and di is the change in current. The inductor value in this circuit is chosen based on a desire to limit the current rise in a 0.5 μs time period to ˜5 A in a 10 kV system. This provides an inductance L of 1 milliHenry (mH).

After the Switch 14 is Turned Off:

After the switch 14 has turned off, the low-side diode 20 (DL) will begin to conduct. The path of the current leaving the output side 12b of inductor 12 (L_{LIMIT}) is dependent on the load conditions. The current leaving the output side 12b of inductor 12 (L_{LIMIT}) will be transferred to either to the breakdown (load) or back to the high voltage regulator or both.

If the breakdown impedance is less than 10 kV/I(L_{LIMIT}): The high-side diode 18 (DH) does not conduct because the beam voltage (V_{beam}) is less than 10 kV and the decreased beam accelerating voltage results in incorrect beam bend radius.

If the breakdown impedance is greater than 10 kV/I(L_{LIMIT}): The high-side diode 18 (DH) will conduct, clamping the beam voltage to 10 kV resulting in the correct output voltage and the correct beam bend radius.

If a fast recovering breakdown occurs: If a fast recovering breakdown recovers to the appropriate output voltage prior to detection and before the high voltage switch 14 turns off, current in L_{LIMIT} may increase because the high voltage switch 14 does not turn off. As the current in L_{LIMIT} increases due to this behavior, the additional current in L_{LIMIT} will be routed back to high voltage regulator 30 by high-side diode 18 (DH) thus keeping the output voltage clamped at the appropriate 10 kV. If these fast recovering (i.e. uninterrupted) breakdowns repeat frequently for a long enough period of time, the current in inductor 12 (L_{LIMIT}) may become large enough that the high voltage switch 14 should be turned off in order to reset the current in L_{LIMIT} to the intended output current. After turning off the high voltage switch 14, the current in L_{LIMIT} will flow though low-side diode 20 (DL) until the L_{LIMIT} current diminishes to the intended value of the output current. At this time the high voltage switch 14 will turn back on.

Example of a 10 kV System

In this example, the circuit is 10 kV and there is a constant 1 kV (1,000V) across the breakdown. A 9 amp (A) per microsecond (μs) current will increase 2.25 A from 1 A to 3.25 A in 0.25 μs. At the time the high voltage switch 14 turns off, the energy stored in the inductor is calculated using the inductance equation (Eq. 2) from above:

E=½(L)(I)²=0.5(0.001)(3.25)²=5.3mJoules

This is very different from conventional technology where the lack of inductive limiting and the ability to interrupt charge transfer from the bulk capacitance into the breakdown results in substantially all the energy in the bulk capacitance being dissipated into the breakdown and done nearly instantaneously (a few μs). In conventional technology where the bulk capacitance is discharged into the breakdown without interruption, the energy dissipated into the breakdown is much larger. For example, a typical switching 10 kV high voltage regulator in the 5 kW range will have about 10-100 nF of bulk filter capacitance. The energy contained in such capacitance at 10 kV is calculated using Eq. 1 from above for capacitors and would be:

E=½(C)(V)²=½(y*10⁻⁹)(10,000)²

where y equals the value of the capacitor in nanoFarads.

For a 10 nF capacitor, the energy dissipated is equal to 0.5 Joules. For a 100 nF capacitor, the energy dissipated is equal to 5 Joules.

The difference in the energy dissipated between the conventional system with a 10 nF capacitor, which is 0.5 Joules or 500 mJoules, with the system of the present invention that includes inductor 12 and switch 14 in series, which is 5.3 mJoules is significant. As can be seen, the amount of arc energy dissipated by the present invention is approximately one one-hundredth the amount of energy dissipated by conventional systems.

It is therefore clear that the advantageous feature of the circuit of the present invention, which provides limitation of the rising current and the ability to quickly interrupt the charge transfer out of the high voltage regulator bulk filter capacitance, results in the ability to drastically reduce the amount of charge being transferred into the establishing breakdown. Drastically reducing the amount of charge being transferred into the establishing breakdown means faster recovery from an arc event.

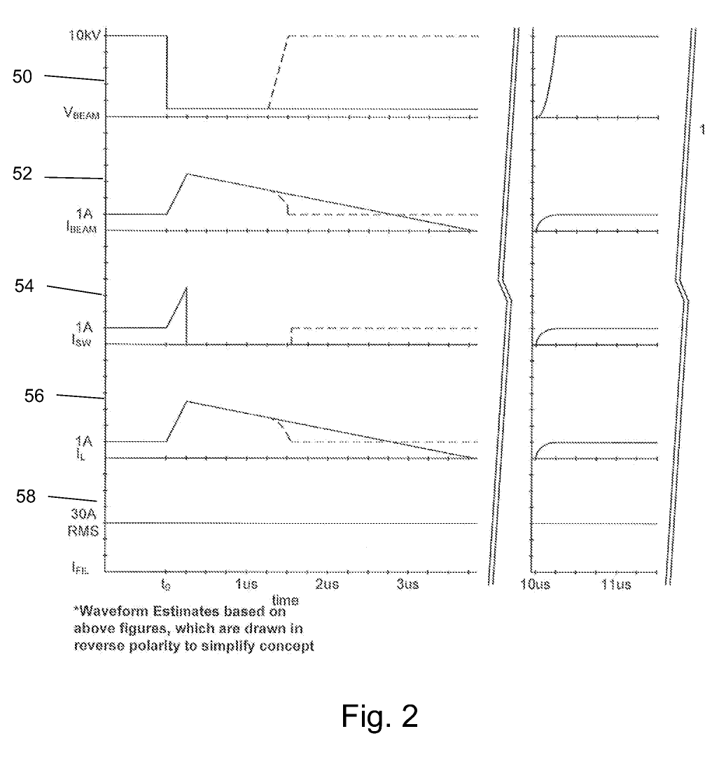

Turning now to FIG. 2, there is illustrated various graphs showing arc recovery performance. The waveforms, which are drawn in reverse polarity for simplification, are based on estimates. As can be seen in FIG. 2, graphs of the beam voltage 50 (V_{beam}), the beam current 52 (I_{beam}), the switch current 54 (I_{sw}), the inductor current 56 (I_{L}) and the filament RMS current 58 are shown plotted against time. Time t₀ represents the start of a breakdown (i.e. arcing event). FIG. 2 is best explained by a description of the operation of the present invention.

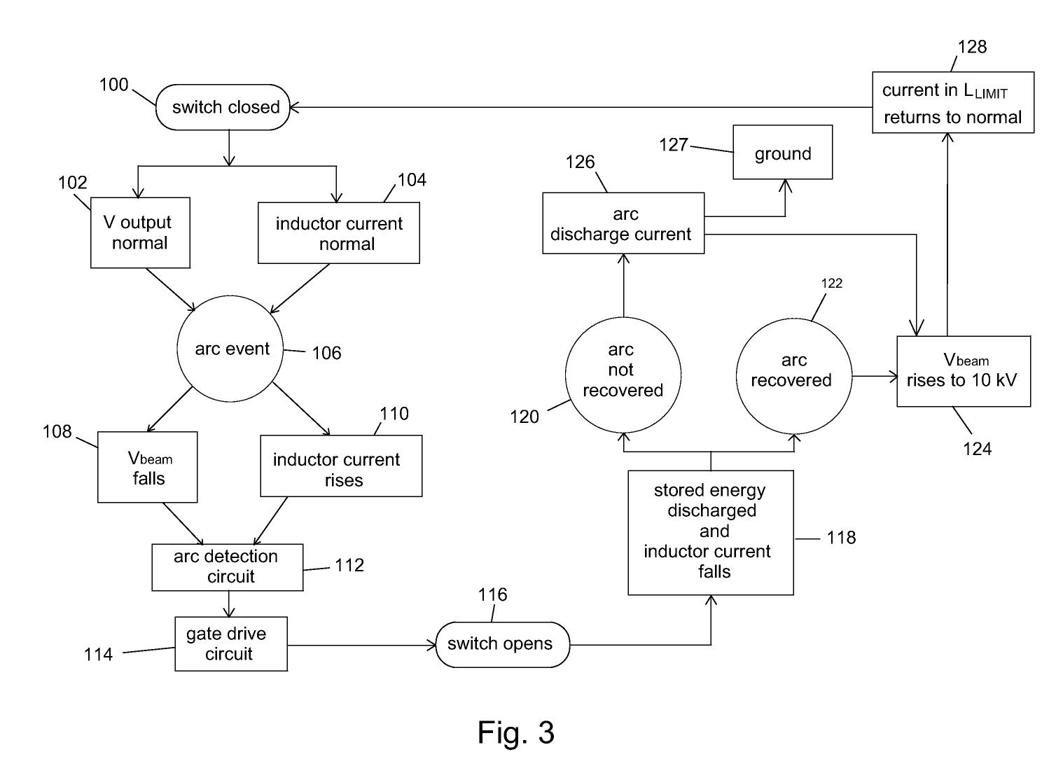

Turning now to FIG. 3, there is illustrated a flow chart depicting the operation of the present invention. As illustrated at step 100, switch 14 is closed and the high voltage power supply is operating normally. This means that the voltage output is normal as shown at step 102 and the inductor current is normal at step 104. At step 106, an arc event occurs. When an arc event occurs, two actions occur simultaneously. The V_{beam} begins to fall (i.e. the voltage decreases) as shown in step 108 and the current through the inductor 12 begins to rise (i.e. the current increases) as shown in step 110. An arc detector circuit at step 112 electrically senses the rapid fall in the V_{beam} from step 108. When a predefined voltage drop threshold is achieved as detected by the arc detector circuit at step 112, a gate drive circuit at step 114 activates switch 14 to open at step 116 as a result of arc detection. When switch 14 opens, the inductor current falls (i.e. decreases) at step 118. The stored energy in the inductor 12 begins to discharge, i.e. the arc discharge current, at step 126. The inductor stored energy either discharges to ground at step 127 through the arc or back to the high voltage regulator through the high-side diode 18 into step 124, or both. When the internal circuitry determines the arc event has passed as indicated by the V_{beam} having recovered and is back to normal at step 124 and current in L_{LIMIT} having diminished to the intended beam current at step 128, the switch 14 is closed and the process is back at step 100 with the high voltage output at normal and the inductor current normal. The circuit is then ready to react when another arc event occurs.

There are many advantages of the present invention. One advantage is that the present invention prevents a complete discharge of energy of the high voltage power supply. Another advantage is a faster recovery time from an arc event due in part to interrupting the energy flow from the high voltage power supply. By interrupting the energy flow from the high voltage power supply, still another advantage is the energy dissipated in the arc is limited to the energy transferred through the limiting inductance of the inductor plus the energy stored in the inductor when the energy flow from the high voltage power supply is interrupted.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. An electrical breakdown limiter circuit for a high voltage power supply, the circuit comprising:
an inductor having an inductor input and an inductor output wherein the inductor is electrically coupled in series between a high voltage output of the high voltage power supply and a load impedance; and
a controllable switch electrically coupled in series with the inductor between the high voltage output of the high voltage power supply and the inductor input wherein the controllable switch is opened when an electrical breakdown event at the load is detected downstream from the inductor output that causes a high voltage at the inductor output to decrease, the controllable switch returning to a normally closed position upon clearing of the electrical breakdown.

2. The circuit of claim 1 further comprising a closed electrical circuit loop electrically coupled to the inductor output and the high voltage output of the high voltage power supply wherein the closed electrical circuit loop clamps the voltage to the load to a predefined voltage level.

3. The circuit of claim 2 wherein the closed electrical circuit loop has a diode.

4. The circuit of claim 3 wherein the diode in the closed electrical circuit loop conducts inductor current when the inductor output voltage is substantially equal to or greater than the high voltage output of the high voltage power supply.

5. The circuit of claim 2 wherein the closed electrical circuit loop includes a high-side diode electrically coupled to the inductor output and the high voltage output of the high voltage power supply and a low-side diode electrically coupled to the inductor input and one of a low side of the high voltage power supply and ground.

6. The circuit of claim 5 wherein the low-side diode is electrically coupled between the inductor input and the controllable switch output.

7. The circuit of claim 5 wherein the high-side diode conducts over-voltage load currents from the inductor output to the high voltage output of the high voltage power supply.

8. The circuit of claim 5 wherein the low-side diode conducts inductor current from the inductor input to one of a low side of the high voltage power supply and ground.

9. The circuit of claim 1 wherein the controllable switch is opened when the high voltage at the inductor output decreases to a predefined voltage value.

10. A method of controlling and limiting the amount of energy dissipated during an arc event in a high voltage power system, the method comprising:
electrically coupling an electrical breakdown limiter circuit between a high voltage output of a high voltage power supply and a load impedance, the electrical limiter circuit having an inductor electrically coupled in series with a controllable switch wherein the controllable switch is normally closed and is electrically coupled to the high voltage output of the high voltage power supply and the inductor output is connected to the load impedance, and a closed electrical circuit loop having a diode electrically coupled between the inductor output on one end of the closed circuit loop and the high voltage output of the high voltage power supply on the opposite end of the closed circuit loop wherein the high voltage output of the high voltage power supply has a predefined, normal operating voltage;
sensing an electrical breakdown event at the load impedance by sensing a decrease in voltage at the inductor output;
electrically opening the controllable switch when the voltage at the inductor output is at or below a predefined voltage level; and
electrically closing the controllable switch when the voltage at the inductor output recovers to the normal operating voltage wherein the inductor and the closed electrical circuit loop limits the rate of rise of electrical current transfer into the load and the controllable switch interrupts the energy transfer from the high voltage output of the high voltage power supply to the load when the electrical breakdown event is detected.
